(19) United States
(12) Patent Application Publication
(10) Pub. No.: US 2011/0066471 A1
(43) Pub. Date: Mar. 17, 2011

(54) DATA MATCHING AND SYNCHRONIZATION BETWEEN TWO APPLICATIONS

(76) Inventors: Hiroshi KITADA, Tuckahoe, NY (US); Lana Wong, Randolph, NJ (US)

(21) Appl. No.: 12/558,174

(22) Filed: Sep. 11, 2009

(51) Int. Cl. G06Q 10/00; G06F 17/30

(52) U.S. Cl. 705/10; 707/622; 707/E17.01; 707/E17.032

(57) ABSTRACT

The invention relates to a method of data matching and synchronization between two applications using at least one management server and a client. The method includes a step of judging whether a sales opportunity in a customer relationship management service is associated with a folder in the document storage service and creating a new folder, obtaining folder identification information, and associating the sales opportunity with the new folder. Also included in the method are steps of creating a new sub-folder in the new folder, the new sub-folder corresponding to a category associated with the sales opportunity, uploading a file associated with the category and the sales opportunity and storing the uploaded file in the new sub-folder.

### BACKGROUND OF THE INVENTION

The present invention relates to a system and method of data matching and synchronization between two applications. Conventionally when using a customer relationship management service such as salesforce.com in concert with a document storage service such as Document Mall, data synchronization and matching between these two applications has been difficult.

### SUMMARY OF THE INVENTION

Accordingly, the present inventions provide inter alia a method of data matching and synchronization between two applications using at least one management server and a client. The method includes a step of judging whether a sales opportunity in a customer relationship management service is associated with a folder in the document storage service by requesting folder identification information from the customer relationship management service and a step of creating a new folder in the document storage service, obtaining folder identification information of the new folder, and associating the sales opportunity with the new folder when the judging determines that a sales opportunity in the customer relationship management service is not associated with a folder in the document storage service. The method further includes steps of creating a new sub-folder in the new folder in the document storage service, the new sub-folder corresponding to a category associated with the sales opportunity, uploading a file associated with the category and the sales opportunity to the document storage service and storing the uploaded file in the new sub-folder.

Also provided is a data matching and synchronization client that includes a judgment unit that determines whether a sales opportunity in a customer relationship management server is associated with a folder in a document storage server by requesting folder identification information from the customer relationship management server and a folder creation unit that transmits a request to the document storage server requesting that a new folder be created and to receive folder identification information corresponding to the new folder when the judgment unit determines that the sales opportunity in the customer relationship management server is not associated with the folder in the document storage server. The data matching and synchronization client also includes an associating unit that associates the sales opportunity with the new folder by transmitting the folder identification information to the customer relationship management server, a sub-folder creation unit that transmits a request to the document storage server requesting that a new sub-folder be created in the folder created by the folder creation unit, the sub-folder corresponding to a category associated with the opportunity in the customer relationship management server, and an upload unit that uploads a document to the document storage server to be stored in the sub-folder corresponding to the category associated with the opportunity in the customer relationship management server.

Also provided is a document storage server executing a document storage service. The document storage server includes a folder creation unit that receives a request to create a new folder, to create the new folder, to generate folder identification information and to send the folder identification information corresponding to the new folder in response to the request and a sub-folder creation unit that receives a request to create a sub-folder in the new folder and to create the sub-folder in the new folder in response to the request. Also included in the document storage server is a file storage unit that receives a document to be stored in the sub-folder and to store the document in the sub-folder in response to the receipt of the document.

Also provided is a customer relationship management server that includes an opportunity information unit that stores a correspondence between a sales opportunity and folder identification information associated with a folder in a document management server and to provide information regarding existence of the folder identification information in response to a request and a category association unit that associates a document with a category corresponding to the sales opportunity.

### BRIEF DESCRIPTION OF SEVERAL VIEWS OF THE DRAWINGS

Other objects, features and advantages of the present invention will become more apparent from the following detailed description when read in conjunction with the accompanying drawings, in which:

FIG. 1 is a block diagram showing an organization of several servers and a client device;

FIG. 2 is a flow diagram showing the interaction between the client device, a salesforce server and a Document Mall server when a folder ID has not yet persisted in salesforce;

FIG. 3 is a flow diagram continuing the flow from FIG. 2;

FIG. 4 is a block diagram illustrating the process of synchronizing folders between the client, the salesforce server and the Document Mall server;

FIG. 5 illustrates a flow diagram showing the interaction between the client, the salesforce server and the Document Mall server when a folder ID has already persisted in salesforce;

FIG. 6 shows a process diagram illustrating the process corresponding to the flow diagram shown in FIG. 5;

FIG. 7 illustrates the correspondence between components of the salesforce server and the components of the Document Mall server;

FIG. 8 illustrates the interaction between the salesforce server, the Document Mall server, the client and an exemplary client interface;

FIG. 9 illustrates the exemplary client interface in which an opportunity is displayed;

FIG. 10 illustrates a flow diagram showing an exemplary process executed when the user selects the view document button;

FIG. 11 illustrates interaction between the salesforce server and the Document Mall server in the display folder contents and upload document processes;

FIG. 12 illustrates an exemplary client interface displayed once the view document button has been selected;

FIG. 13 illustrates an exemplary client interface showing the window displayed when the add document button is selected;

FIG. 14 is a flow diagram illustrating the process of another embodiment of the invention performed when the add document button is selected;

FIG. 15 is a block diagram illustrating an embodiment of the invention; and

FIG. 16 is a hardware configuration of an apparatus according to an embodiment of the present invention.

### DETAILED DESCRIPTION OF THE INVENTION

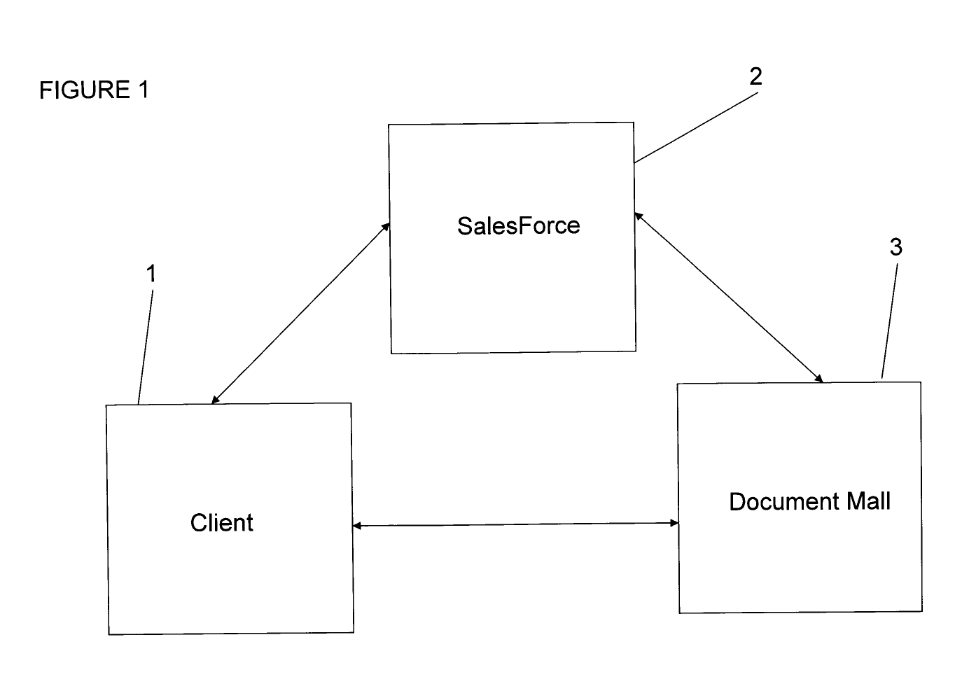

Referring now to the drawings, wherein like reference numerals designate identical or corresponding parts throughout the several views and more particularly to FIG. 1 thereof there is illustrated the structure of the present system for synchronizing folders between a document storage service and a customer relation management service. FIG. 1 illustrates the structure of the system which includes a client 1, a customer relationship management server 2 (the customer relationship management server 2 may be implemented using for example a salesforce enabled server, herein “salesforce server 2”) and a document storage server 3 (the document storage server 3 may be implemented using for example a document mall enabled server, herein “Document Mall server 3”). As is illustrated in FIG. 1, the client 1 is able to interact with both the salesforce server 2 and the Document Mall server 3 directly or indirectly.

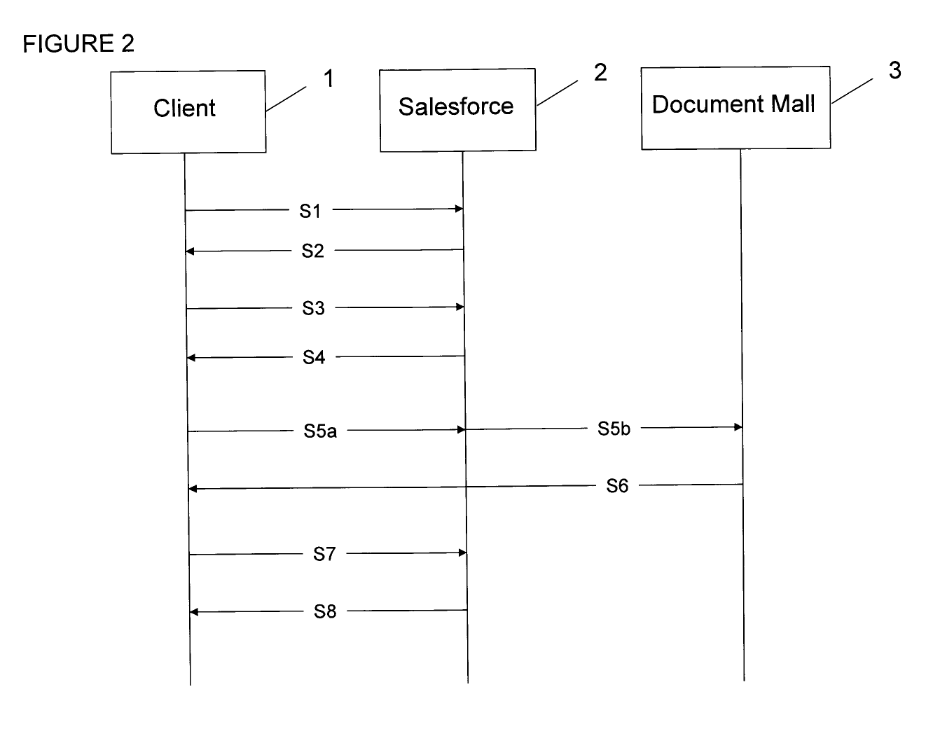

FIG. 2 illustrates the flow diagram showing the interaction between the client salesforce server 2 and the Document Mall server 3 in the case that the Document Mall folder ID has not yet persisted in salesforce. The Document Mall folder ID is said to have “persisted” in salesforce when the folder ID has been matched to an opportunity in the salesforce system.

As is shown in FIG. 2, when the user of the client 1 selects an attach/upload file function, the client 1 sends a request to the salesforce server 2 (S1) requesting a folder ID which is stored in a DM_folder_info file on the salesforce server 2.

In FIG. 2 there is illustrated the case where the Document Mall folder ID has not yet persisted in the salesforce system. Thus, in step S2, an error is sent indicating the failure to retrieve the folder ID. Further, in step S3, the client 1 sends a request to obtain information regarding the opportunity to which the file is to be attached, the information relating to the name of the opportunity, for example.

This information is then relayed back to the client 1 from the salesforce server 2 in step S4. In steps S5a and S5b, the client 1 sends a request to have the Document Mall server 3 create a folder ID which corresponds to the opportunity retrieved in step S4. Specifically, in step S5a, the request is sent from the client 1 to a salesforce server 2 and in step S5b the salesforce server 2 forwards the request to the Document Mall server 3. In step S6, the Document Mall server 3 generates the folder ID and sends the generated folder ID back to the client 1.

In step S7, the client 1 forwards the received folder ID to the salesforce server 2 such that the folder ID is saved in the DM_folder_info file on the salesforce server 2. This step matches the folder ID with the opportunity for which the user originally requested that the file be attached.

In step S8, an error status or confirmation status indicating whether the folder ID has been properly received and matched to the opportunity is sent from the salesforce server 2 to the client 1.

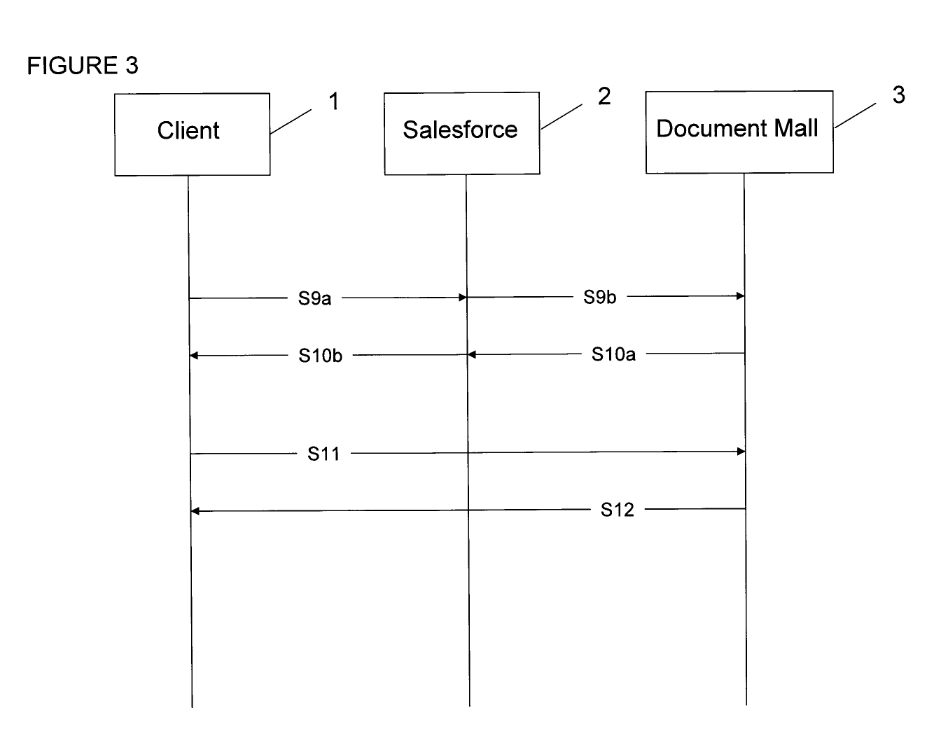

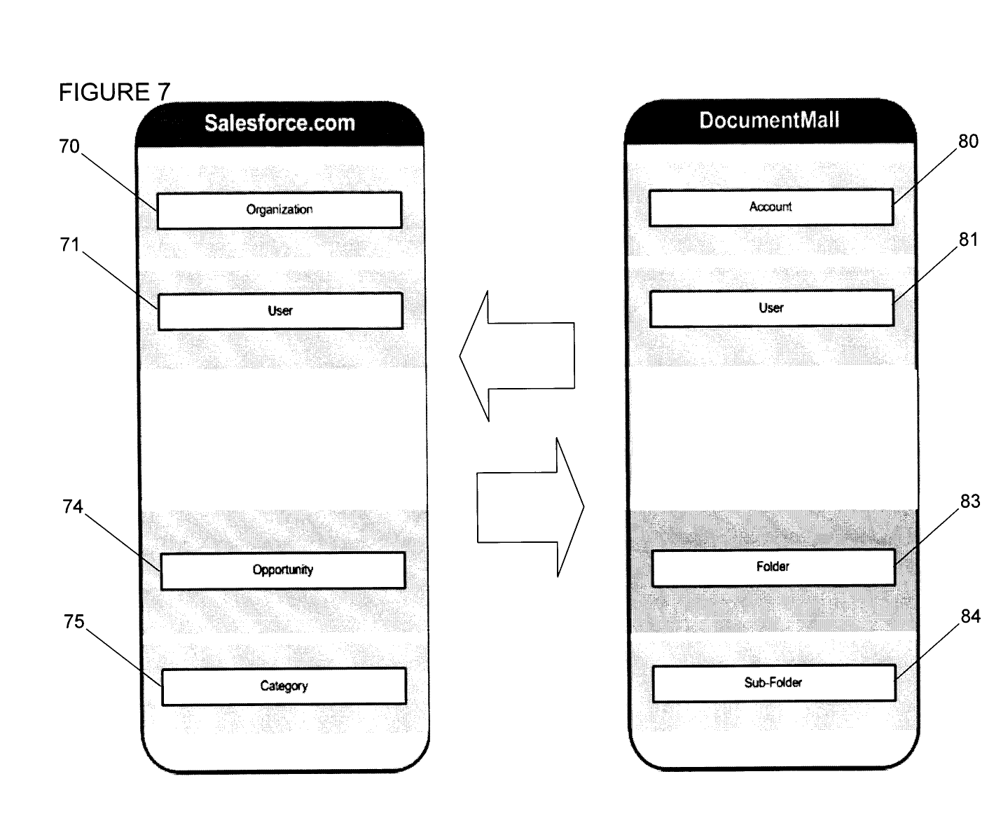

FIG. 3 continues the process shown in FIG. 2. In step S9a the client sends a request to the Document Mall server 3 via the salesforce server 2. The request sent in step S9a requests that the Document Mall server 3 create a sub-folder within the folder created previously in step S5, the subfolder folder corresponding to a category in the salesforce server. As will be discussed in more detail with regard to FIG. 7, categories are organizational subsections of an opportunity. Thus, a document which is associated with an opportunity may also be associated with a category. For example, an opportunity may include categories such as contract, customer information, order documents, quote, RFP RFQ or other. Additional categories are also possible. In step S9a the client 1 forwards the request to the salesforce server 2 and in step S9b the salesforce server 2 forwards the request on to Document Mall server 3.

In steps S10a and Slob, a confirmation or error status indicating whether the request is successful is sent from the Document Mall server 2 to the client 1 via the salesforce server 2.

In step 11, the client 1 uploads the file to be stored in the subfolder corresponding to a category in salesforce to the Document Mall server 3. In step 12, a confirmation or error status is returned to the client 1 from the Document Mall server 3.

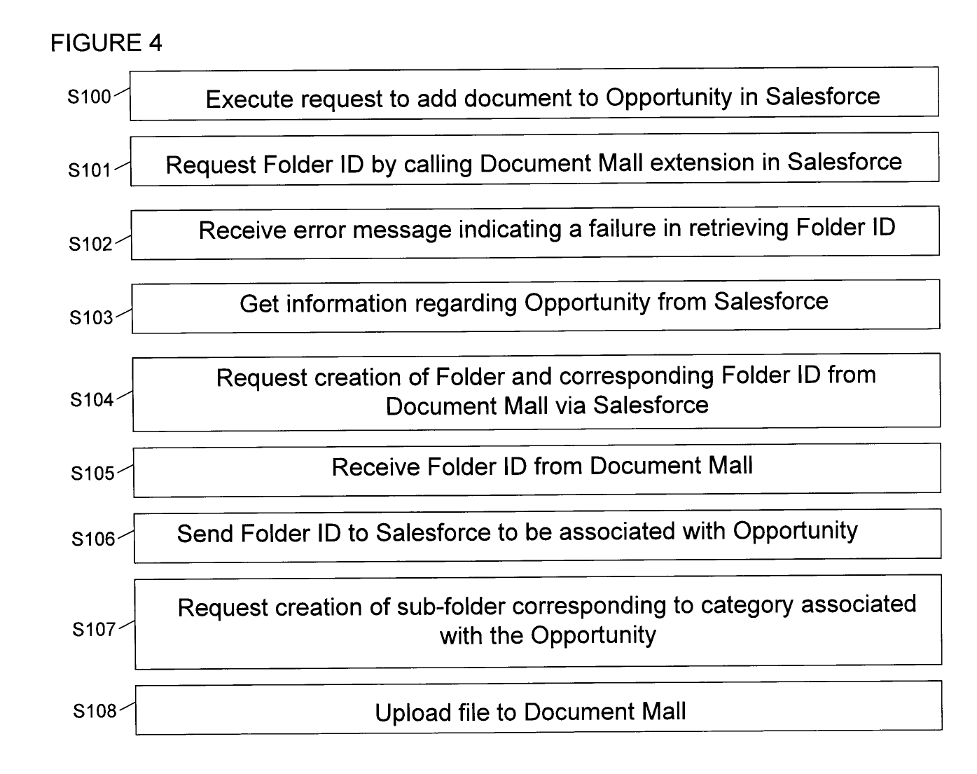

FIG. 4 illustrates a process diagram corresponding to the flow diagram shown in FIGS. 2 and 3. Specifically in step 100, a request is executed in the client 1 to add a document to an opportunity in salesforce. In step 101, the client 1 requests a folder ID of a folder in the Document Mall server 3 corresponding to the opportunity associated with the request in step 100 by calling the document mall extension in salesforce. Because the document mall folder ID has not yet persisted in salesforce, in step 102, an error message is received indicating failure of retrieval of the folder ID.

In step 103, information regarding the opportunity associated with the request in step 100 is retrieved from the salesforce server 2. In step 104, a request is sent to the Document Mall server 3 requesting creation of a folder and corresponding folder ID corresponding to the opportunity associated with the request in step 100, the request being sent via the salesforce server 2.

In step 105, the generated folder ID is received from the Document Mall server 3. In step 106, the folder ID previously received in step 105 is sent to salesforce server 2 to be associated with the opportunity to which the document request is directed in step 100.

In step 107, a request is sent requesting creation of a subfolder in the Document Mall server 3 corresponding to a category associated with the opportunity. In step 108, the file is uploaded to the Document Mall server 3 to be stored in the subfolder corresponding to the category.

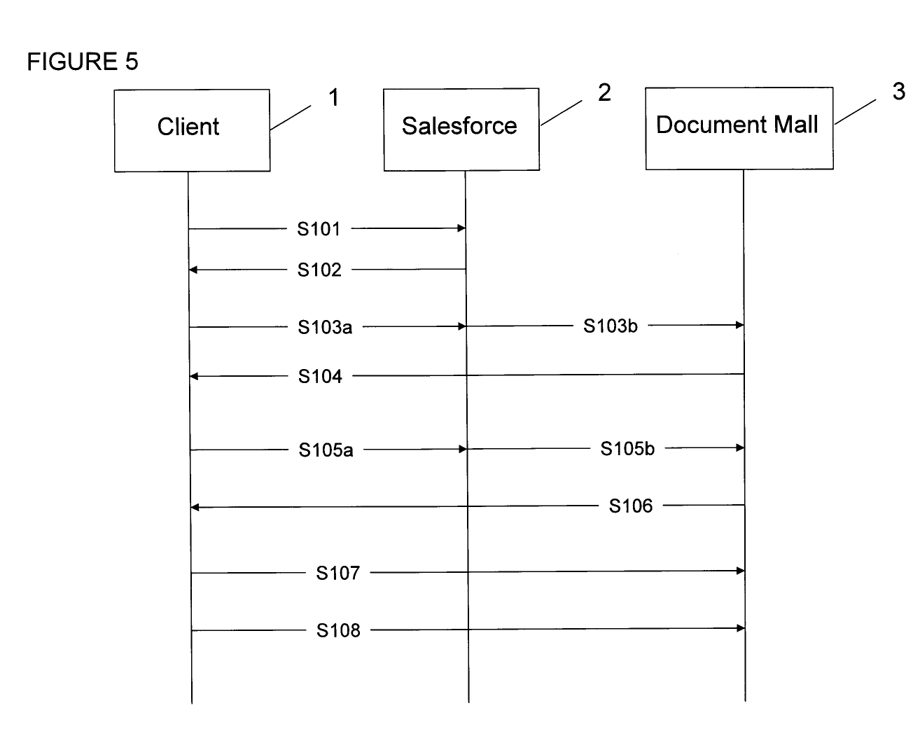

FIG. 5 shows the interaction between the client 1, the salesforce server 2 and the Document Mall server 3 in the case in which the Document Mall folder ID has already persisted in salesforce. As was noted above, the Document Mall folder ID is considered to be persisted in salesforce when the folder ID is stored in a DM_folder_info file corresponding to an opportunity.

In FIG. 5, when the user selects the attach/upload file function for an opportunity, the client 1 sends a get folder ID request, in step S101, to the salesforce server 2. Due to the fact that the document folder ID has already persisted in salesforce in the present case, the folder ID is returned to the client from the salesforce server 2 in step S102. In steps S103a and S103b, the client 1 requests that the Document Mall server 3 provide the name of the folder corresponding to the folder ID. This request is sent via the salesforce server 2.

In step S104, the Document Mall server 3 returns the folder name to the client 1. Steps S103 and 5104 are performed in order to ensure that the folder corresponding to the folder ID still exists and is accessible in the Document Mall server 3.

In steps S105a and S105b, the client 1 sends a request via the salesforce server 2 to the Document Mall server 3 requesting that a subfolder be created corresponding to a category associated to the opportunity. In step S106, a confirmation or error status message is returned from the Document Mall server 3 to the client 1.

In step 107, the client uploads the file to the Document Mall server 3 to be stored in the subfolder corresponding to the category created in step 105. In step 108, the Document Mall server 3 sends a confirmation or error status message to the client 1.

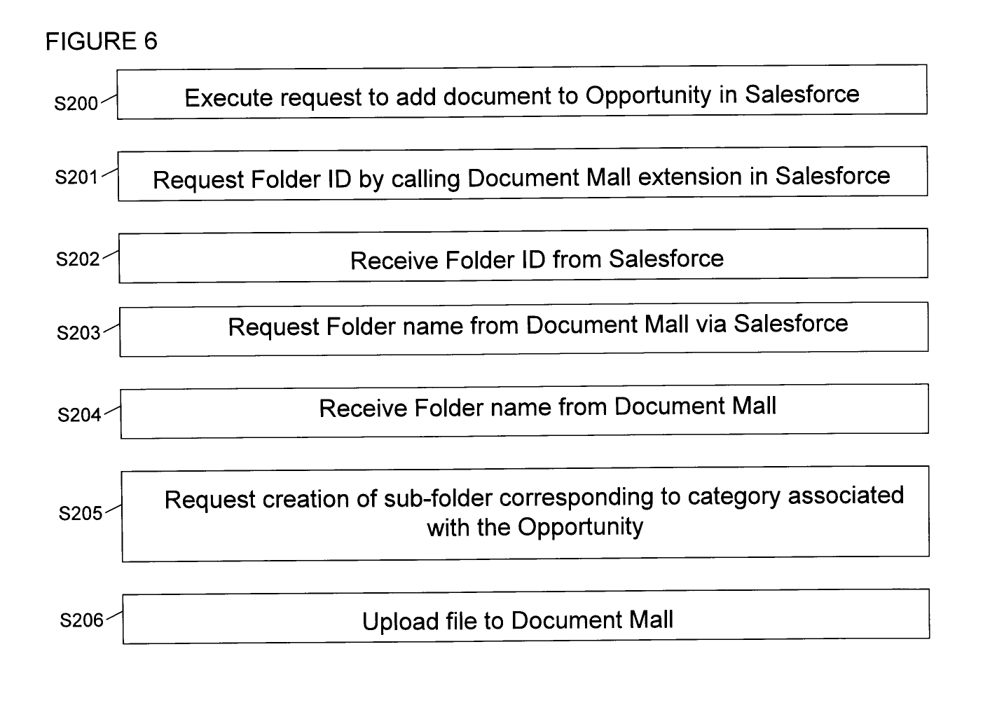

FIG. 6 shows a process diagram corresponding to the flow diagram shown in FIG. 5. In step S200, a request is executed in the client 1 to add a document to an opportunity in salesforce. In step S201, the folder ID identifying a folder in the Document Mall server 3 that corresponds to the opportunity associated with the request executed in S200 is requested by calling the Document Mall extension in salesforce.

In step S202, the folder ID is received from the salesforce server 2. In step S203, a folder name corresponding to the folder ID is requested from the Document Mall server 3 via the salesforce server 2. In step S204, the folder name is received from the Document Mall server 3. In step S205, the creation of a subfolder matching a category corresponding to the opportunity associated with the request in S200 is requested. In step S206, the file is uploaded to Document Mall server 3 to be stored in the subfolder created in step S205.

FIG. 7 illustrates the correspondence between components of the salesforce server 2 from the Document Mall server 3. Specifically, an organization 70 in the salesforce server 2 corresponds to an account 80 in the Document Mall server 3. For example, an account can be created in the Document Mall server 3 which corresponds to an organization in salesforce. Thus, as a result opportunities in the salesforce system can be linked to folders in the Document Mall server 3 which are associated with the created account.

Further a user 71 in the salesforce server 2 corresponds to a user 81 in the Document Mall server 3. In addition, an opportunity 74 in the salesforce server 2 is associated with a folder 83 in the Document Mall server 3 and a category 75 in the salesforce server 2 is associated with a subfolder 84 in the Document Mall server 3.

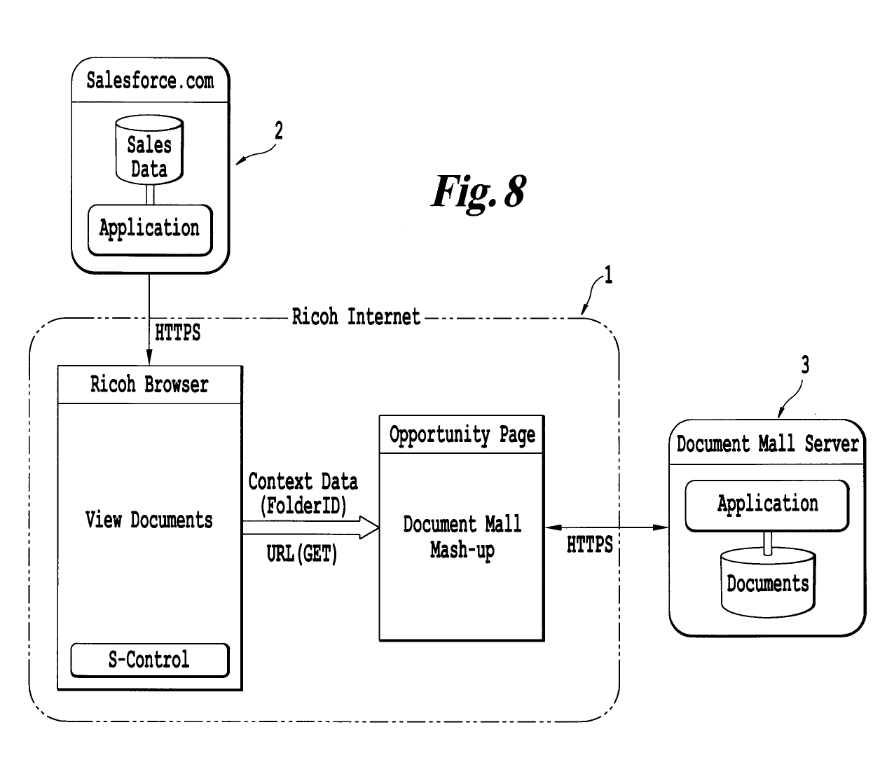

FIG. 8 provides another illustration of the interaction between the salesforce server 2, the client 1 and the Document Mall server 3.

As is illustrated in FIG. 8, the client 1 provides information to the user by way of a browser, for example, which interacts with the salesforce server 2 and provides information regarding certain customer relationship management functions. In addition, when the user of the salesforce interface on the client 1 selects an opportunity detail page and selects the view document option, the Document Mall server 3 provides information to the user, by way of the client 1, regarding documents that are stored in the Document Mall server 3 which correspond to the selected opportunity.

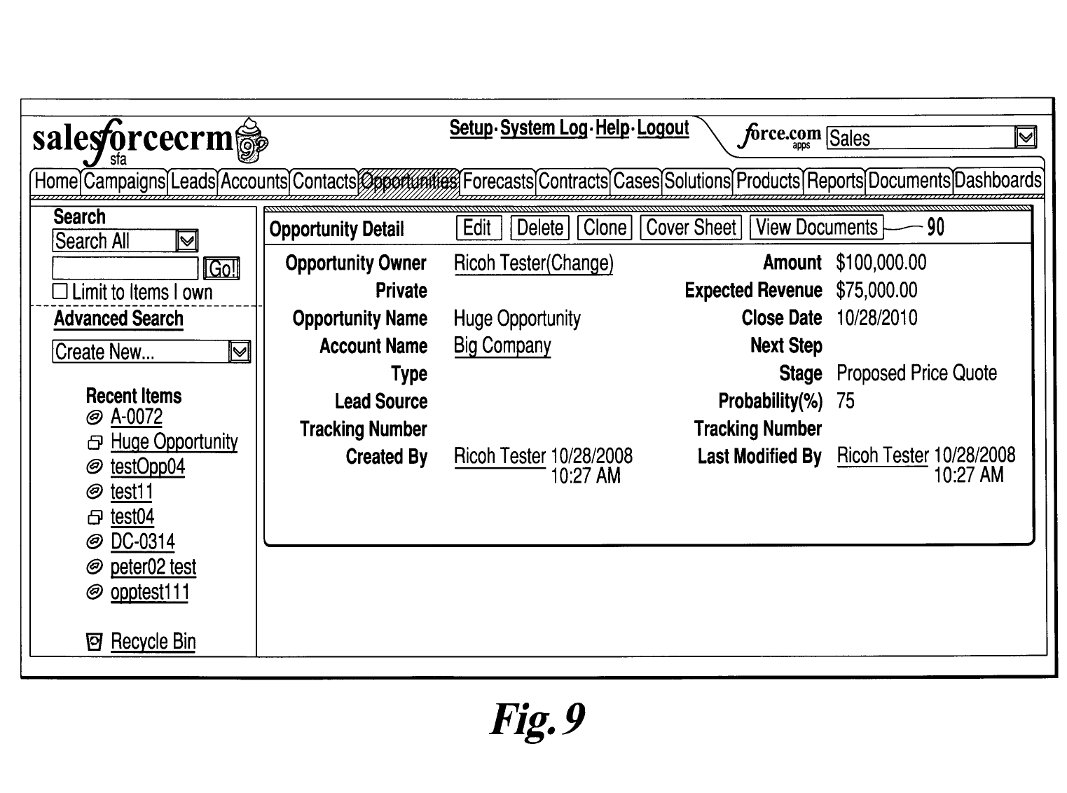

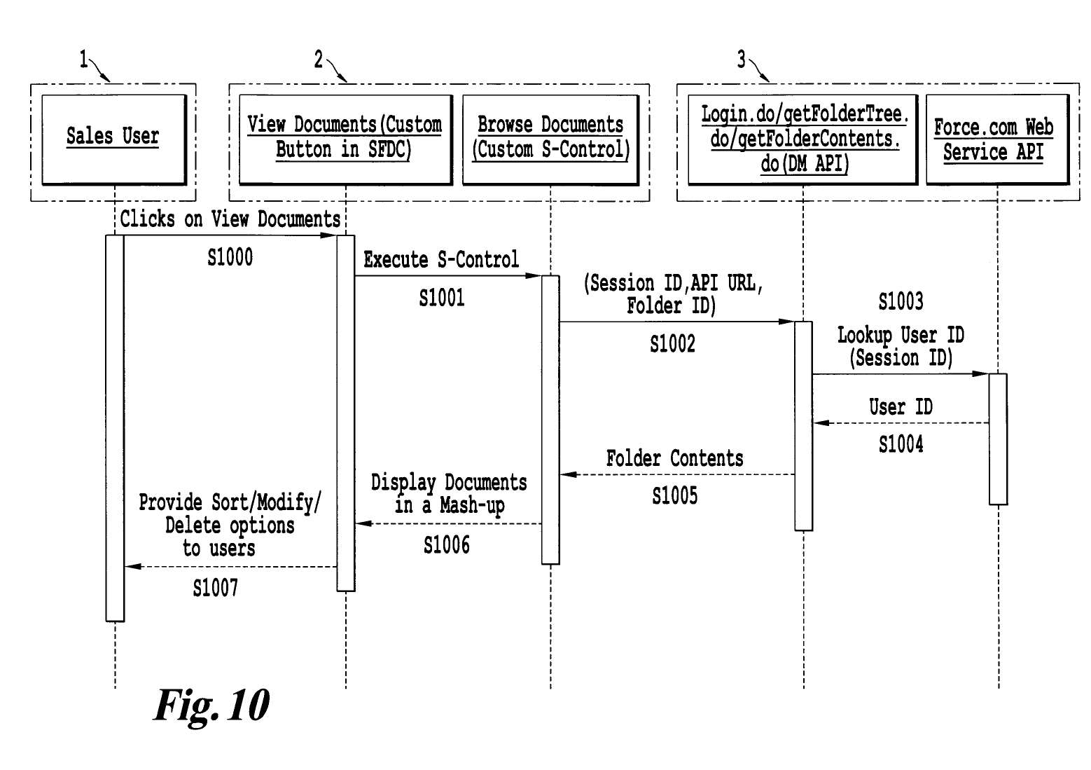

FIG. 9 illustrates an example of the salesforce interface on the client 1. In the example shown in FIG. 9, the opportunity tab is highlighted indicating that a particular opportunity has been selected and is being displayed in detail. Specifically, the window shown in FIG. 9 provides information regarding the selected opportunity including the opportunity owner, the opportunity name, the account name, as well as other information regarding the opportunity. In addition, the user is able to select the view documents button 90 from the opportunity detail window.

The view documents button 90 when selected executes a function which enables the user to see what documents stored in the document mall server 3 are associated with the selected opportunity displayed in FIG. 9.

FIG. 10 illustrates a flow diagram showing the process performed when the user selects the view documents button 90 shown in FIG. 9. When the user accessing the salesforce interface on the client 1 selects the view documents button 90 in step 1000, the view documents button executes a custom S-control or function in the salesforce server 2. This custom S-control interacts with the Document Mall server 3 by accessing the Document Mall API URL.

Specifically, the custom S-control sends a request via the Document Mall API to the Document Mall server 3 requesting information regarding documents stored therein. The request includes information attached therewith such as the session ID of the client's 1 salesforce session and the folder ID of the folder in the Document Mall server which corresponds to the selected opportunity.

In the present embodiment, in order to log into the Document Mall server 3 the session ID is used to look up the salesforce user ID which corresponds to the Document Mall user ID in step 1003. The user ID is then returned in step 1004 to the Document Mall server 3 enabling a listing of the folder contents in step 1005.

The folder contents are then displayed in a mash-up in step 2006 and an option is displayed enabling the user to sort, modify or delete the displayed documents in step 1007.

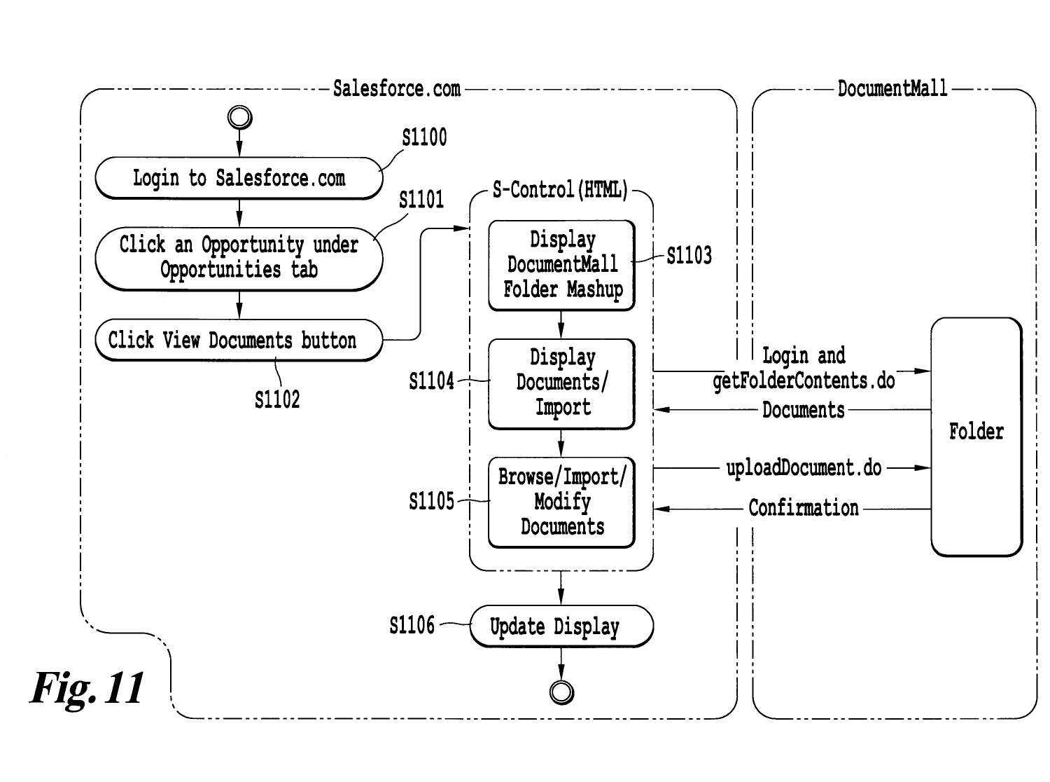

FIG. 11 illustrates the interaction between the salesforce server 2 and the Document Mall server 3, specifically when the documents stored in a particular folder in the Document Mall server 3 are displayed or when a new document is added to the Document Mall server 3.

As is shown in FIG. 11, in step S1100, the user logs into the salesforce interface. In step 1101, an opportunity is selected in the salesforce interface. In step 1102, the view documents button 90 is selected. This action executes the custom S-control which displays the document mall folder mash-up in step S1102. This mash up requires documents to be imported and displayed in step 1103. In order to perform this function the salesforce interface accesses the Document Mall server 3, logs in, and retrieves a list of the corresponding documents. Further, in step S1104, if the user wishes to import or modify documents stored in the document mall server 3, the custom S-control again accesses the Document Mall server 3, uploads documents and receives a confirmation. Finally, in step S1105, the display is updated.

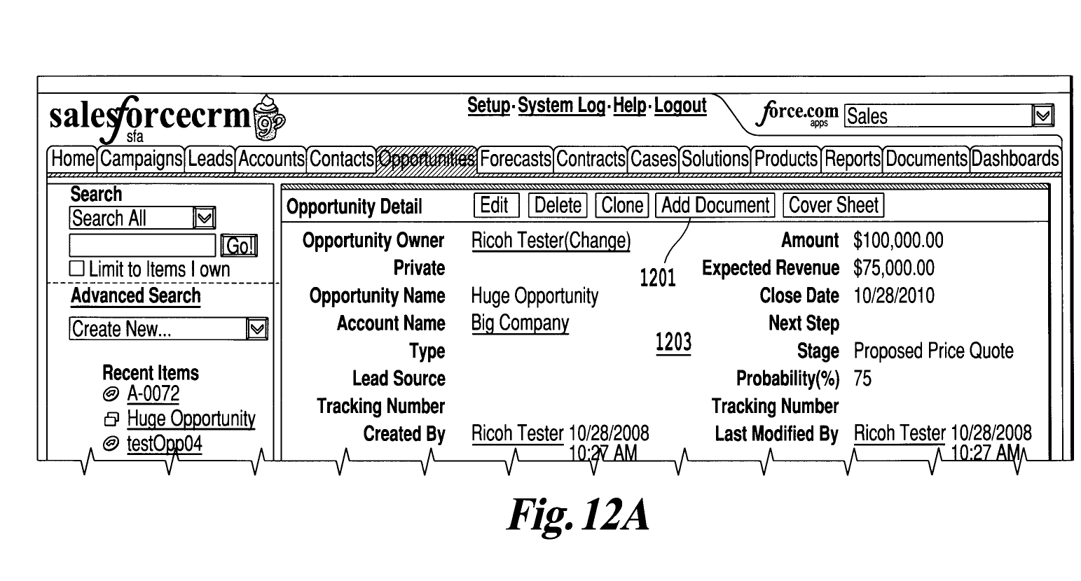

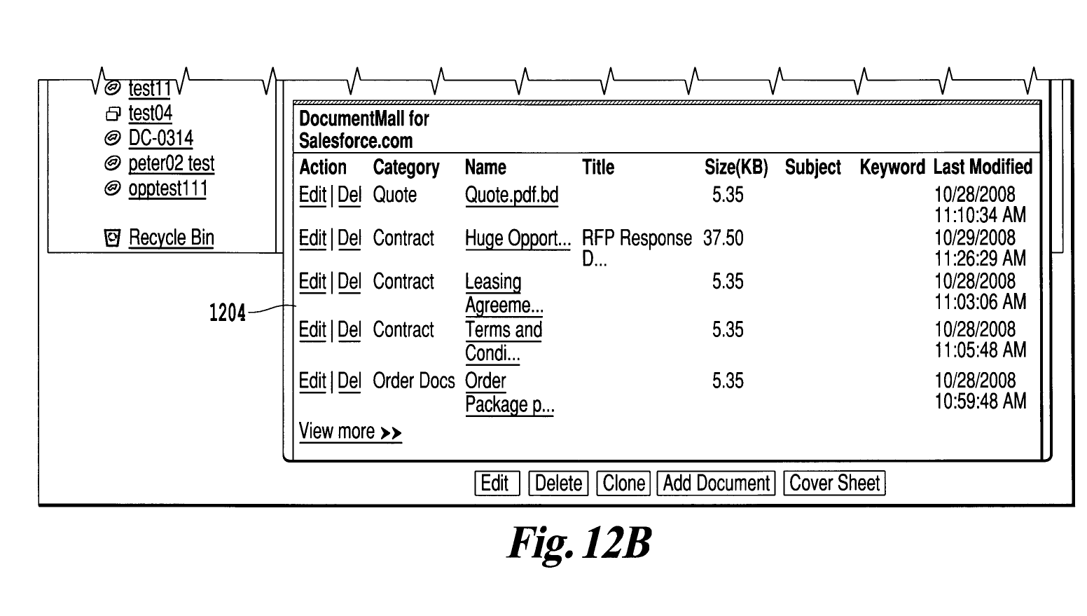

FIG. 12 provides an example of the salesforce interface and the window displayed once the view documents button 90 has been selected. As can be seen in FIG. 12, this window includes a selectable add document button 1201. In addition, the opportunity detail 1203 which was displayed before the view document button 90 was selected remains displayed. In addition, the window includes a list of documents 1204 stored in the Document Mall server 3 which correspond to the selected opportunity.

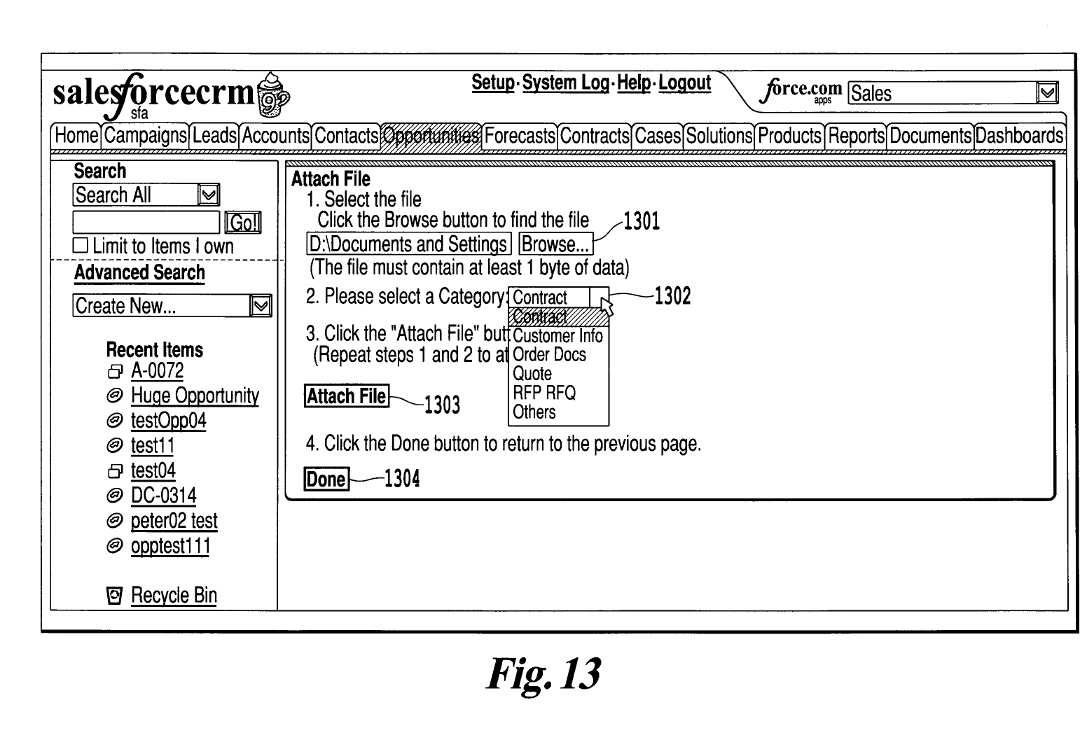

When the user selects the add document button 1201, the window displayed in FIG. 13 is shown. FIG. 13 illustrates the window which enables a user to upload a document to the document mall server 3 in a folder corresponding to the selected opportunity.

Specifically the user is able to select a document from a local or remote location using file input box 1301. Further, the user is able to select a category in drop-down box 1302. This category, as noted earlier, corresponds to a subfolder in the folder associated with the selected opportunity on the Document Mall server 3. Once the user has selected the file and the category, the user is able to execute the upload using the attach file button 1303. Once the user has completed the upload, the user can select the done button 1304 to return to the opportunity detail page.

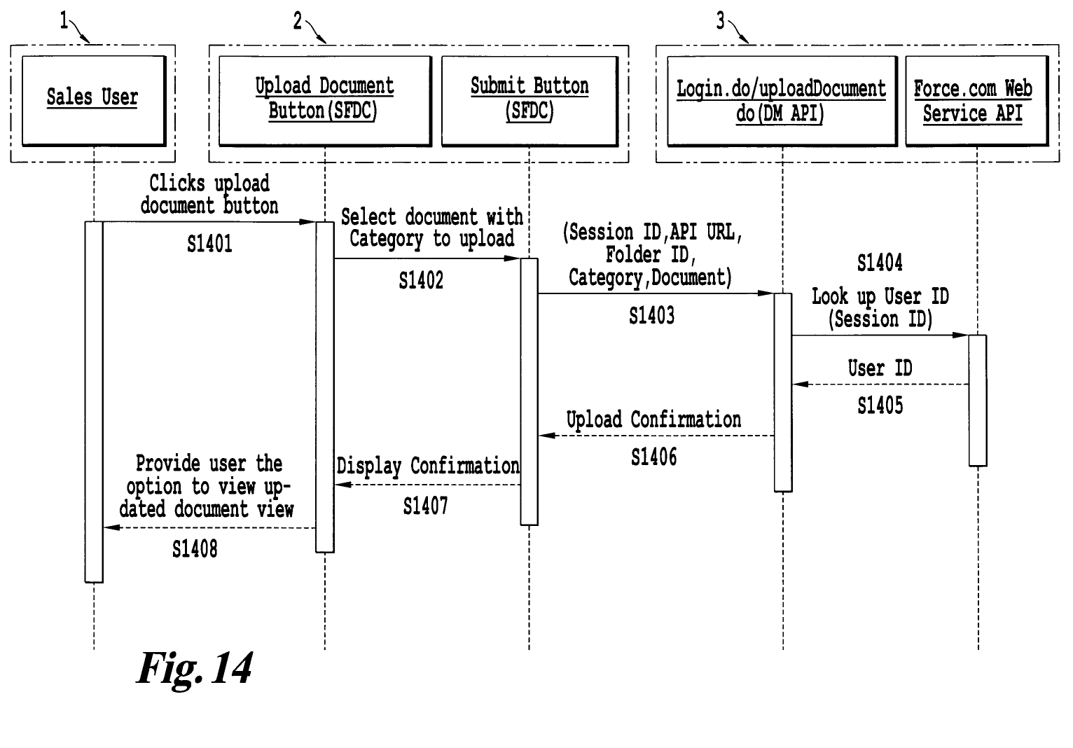

FIG. 14 shows another embodiment illustrating the process of uploading a document to the Document Mall server 3. As is shown in FIG. 14, when the user of the client 1 selects the upload document button or add document button, in step 1401. In response, the window is displayed which allows the user of the client 1 to upload a document and select a category for the added document in step S1402. Once the attach file or submit button 1301 is selected, a request is executed, in step 1403, which uploads the document to the Document Mall server 3. This request includes the session ID of the salesforce session, the folder ID of the folder in the Document mall server 3 which corresponds to the selected opportunity, the selected category and the uploaded document data. The Document Mall server 3 then, in step S1404, looks up the salesforce user ID from the salesforce server 2 based on the session ID and this user ID is returned to the Document Mall server 3 in step S1405 and is used to authenticate the DM request. Once the process has been completed and the document has been added to the specific subfolder on the Document Mall server 3, an upload confirmation is sent back to the salesforce interface in step 1406. Further, this confirmation is displayed in step S1407 and the user is provided an option to update the document view in step S1408.

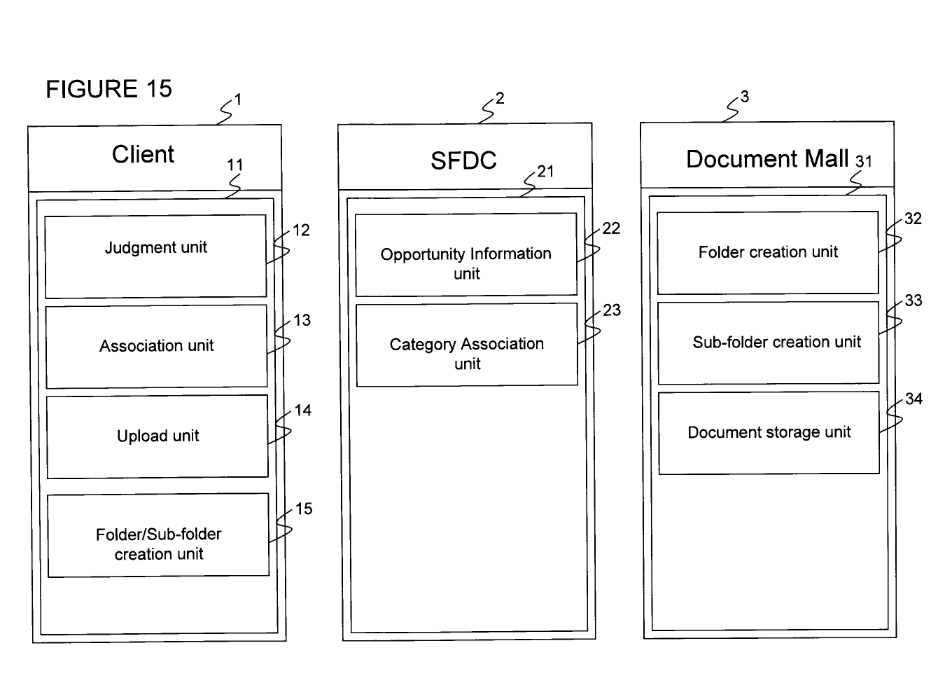

In addition, as is shown in FIG. 15 each of the client 1, the salesforce.com server 2 and the Document Mall server 3, includes at least one processor.

The processor 11 in the client device 1 has, at least, a judgment unit 12, an association unit 13, an upload unit 14, and a folder/sub-folder creation unit 15.

The judgment unit 12 judges whether an opportunity in the salesforce server 2 is associated with a folder in the document mall server 3 by requesting folder identification information from the salesforce server 2.

The folder/sub-folder creation unit 15 transmits a request to the document mall server 3 requesting that a new folder be created and to receive folder identification information corresponding to the new folder when the judgment unit 12 determines that the opportunity in the salesforce server 2 is not associated with the folder in the document mall server 3.

Further, the folder/sub-folder creation unit 15 transmits a request to the document mall server 3 requesting that a new sub-folder be created in the folder created by the folder creation unit, the sub-folder corresponding to a category associated with the opportunity in the salesforce server 2.

The associating unit 13 associates the opportunity with the new folder by transmitting by the folder identification information to the salesforce server 2.

The upload unit 14 uploads a document to the document mall server 3 to be stored in the sub-folder corresponding to the category associated with the opportunity in the salesforce server 2.

The processor 31 in the document mall server 3 includes, at least, a folder creation unit 32, a sub-folder creation unit 33 and a document storage unit 34.

The folder creation unit 32 receives a request to create a new folder, creates the new folder, generates folder identification information and sends the folder identification information corresponding to the new folder to the client 1 in response to the request.

The sub-folder creation unit 33 receives a request to create a sub-folder in the new folder and creates the sub-folder in the new folder in response to the request.

The file storage unit 34 receives a document to be stored in the sub-folder and stores the document in the sub-folder in response to the receipt of the document.

The processor 21 in the salesforce server 2 includes, at least, an opportunity information unit 22 and a category association unit 23.

The opportunity information unit 22 stores a correspondence between an opportunity and folder identification information associated with a folder in a document mall server 3 and provides information regarding an existence of the folder identification information in response to a request.

The category association unit 23 associates a document with a category corresponding to the opportunity.

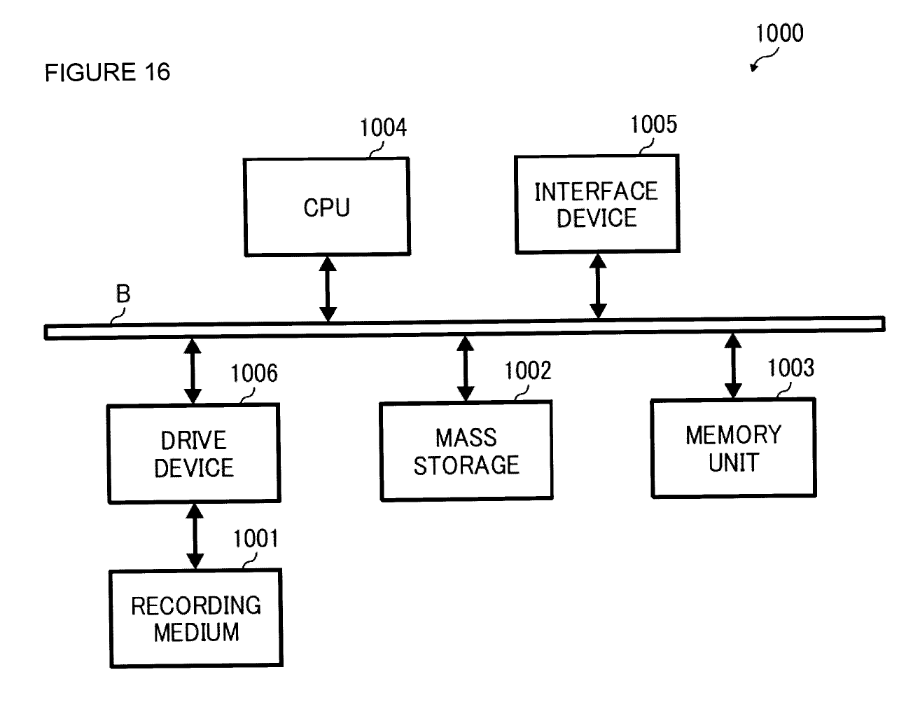

FIG. 16 illustrates a computer system 1000 upon which an embodiment of the present invention may be implemented. The computer system 1000 includes a bus B or other communication mechanism for communicating information, and a processor/CPU 1004 coupled with the bus B for processing the information. The computer system 1000 also includes a main memory/memory unit 1003, such as a random access memory (RAM) or other dynamic storage device (e.g., dynamic RAM (DRAM), static RAM (SRAM), and synchronous DRAM (SDRAM)), coupled to the bus B for storing information and instructions to be executed by processor/CPU 1004. In addition, the memory unit 1003 may be used for storing temporary variables or other intermediate information during the execution of instructions by the CPU 1004. The computer system 1000 may also further include a read only memory (ROM) or other static storage device (e.g., programmable ROM (PROM), erasable PROM (EPROM), and electrically erasable PROM (EEPROM)) coupled to the bus B for storing static information and instructions for the CPU 1004.

The computer system 1000 may also include a disk controller coupled to the bus B to control one or more storage devices for storing information and instructions, such as mass storage 1002, and drive device 1006 (e.g., floppy disk drive, read-only compact disc drive, read/write compact disc drive, compact disc jukebox, tape drive, and removable magneto-optical drive). The storage devices may be added to the computer system 1000 using an appropriate device interface (e.g., small computer system interface (SCSI), integrated device electronics (IDE), enhanced-IDE (E-IDE), direct memory access (DMA), or ultra-DMA).

The computer system 1000 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1000 may also include a display controller coupled to the bus B to control a display, such as a cathode ray tube (CRT), for displaying information to a computer user. The computer system includes input devices, such as a keyboard and a pointing device, for interacting with a computer user and providing information to the processor. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system 1000 performs a portion or all of the processing steps of the invention in response to the CPU 1004 executing one or more sequences of one or more instructions contained in a memory, such as the memory unit 1003. Such instructions may be read into the memory unit from another computer readable medium, such as the mass storage 1002 or a removable media 1001. One or more processors in a multi-processing arrangement may also be employed to execute the sequences of instructions contained in memory unit 1003. In alternative embodiments, hard-wired circuitry may be used in place of or in combination with software instructions. Thus, embodiments are not limited to any specific combination of hardware circuitry and software.

As stated above, the computer system 1000 includes at least one computer readable medium 1001 or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other medium from which a computer can read.

Stored on any one or on a combination of computer readable media, the present invention includes software for controlling the computer system 1000, for driving a device or devices for implementing the invention, and for enabling the computer system 1000 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the CPU 1004 for execution. A computer readable medium may take many forms, including but not limited to, non-volatile media, and volatile media. Non-volatile media includes, for example, optical, magnetic disks, and magneto-optical disks, such as the mass storage 1002 or the removable media 1001. Volatile media includes dynamic memory, such as the memory unit 1003.

Various forms of computer readable media may be involved in carrying out one or more sequences of one or more instructions to the CPU 1004 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1000 may receive the data on the telephone line and use an infrared transmitter to convert the data to an infrared signal. An infrared detector coupled to the bus B can receive the data carried in the infrared signal and place the data on the bus B. The bus B carries the data to the memory unit 1003, from which the CPU 1004 retrieves and executes the instructions. The instructions received by the memory unit 1003 may optionally be stored on mass storage 1002 either before or after execution by the CPU 1004.

The computer system 1000 also includes a communication interface 1005 coupled to the bus B. The communication interface 1005 provides a two-way data communication coupling to a network that is connected to, for example, a local area network (LAN), or to another communications network such as the Internet. For example, the communication interface 1005 may be a network interface card to attach to any packet switched LAN. As another example, the communication interface 1005 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1005 sends and receives electrical, electromagnetic or optical signals that carry digital data streams representing various types of information. Also included may be a display interface which enables user interaction with the device.

The network typically provides data communication through one or more networks to other data devices. For example, the network may provide a connection to another computer through a local network (e.g., a LAN) or through equipment operated by a service provider, which provides communication services through a communications network. The local network and the communications network use, for example, electrical, electromagnetic, or optical signals that carry digital data streams, and the associated physical layer (e.g., CAT 5 cable, coaxial cable, optical fiber, etc). The signals through the various networks and the signals on the network and through the communication interface 1005, which carry the digital data to and from the computer system 1000 maybe implemented in baseband signals, or carrier wave based signals. The baseband signals convey the digital data as un-modulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as un-modulated baseband data through a “wired” communication channel and/or sent within a predetermined frequency band, different than baseband, by modulating a carrier wave. The computer system 1000 can transmit and receive data, including program code, through the network and the communication interface 1005. Moreover, the network may provide a connection to a mobile device such as a personal digital assistant (PDA) laptop computer, or cellular telephone.

The present invention is not limited to the specifically disclosed embodiments, and variations and modifications may be made without departing from the scope of the present invention.

1. A method of data matching and synchronization between two applications using at least one management server and a client comprising:
judging whether a sales opportunity in a customer relationship management service is associated with a folder in the document storage service by requesting folder identification information from the customer relationship management service;
creating a new folder in the document storage service, obtaining folder identification information of the new folder, and associating the sales opportunity with the new folder when the judging determines that a sales opportunity in the customer relationship management service is not associated with a folder in the document storage service;
creating a new sub-folder in the new folder in the document storage service, the new sub-folder corresponding to a category associated with the sales opportunity;
uploading a file associated with the category and the sales opportunity to the document storage service; and
storing the uploaded file in the new sub-folder.

2. The method according to claim 1, wherein the requesting folder identification information further includes sending a request which includes information relating to the sales opportunity.

3. The method according to claim 1, further comprising:
creating a second new sub-folder in the new folder in the document storage service, the second new sub-folder corresponding to a second category associated with the sales opportunity.

4. The method according to claim 3, further comprising:
uploading a second file associated with the second category and the sales opportunity to the document storage service.

5. The method according to claim 4, further comprising:
storing the uploaded second file in the second new sub-folder.

6. The method according to claim 1, wherein the step of creating a new folder in the document storage service, obtaining folder identification information of the new folder, and associating the sales opportunity with the new folder is performed in response to receipt at the document storage service of a request to create a folder sent by the client.

7. The method according to claim 6, wherein the client sends the request to create a folder to the document storage service in response to a message from the customer relationship management service indicating that the sales opportunity in the customer relationship management service is not associated with a folder in the document storage service.

8. A data matching and synchronization client comprising:
a judgment unit configured to determine whether a sales opportunity in a customer relationship management server is associated with a folder in a document storage server by requesting folder identification information from the customer relationship management server;
a folder creation unit configured to transmit a request to the document storage server requesting that a new folder be created and to receive folder identification information corresponding to the new folder when the judgment unit determines that the sales opportunity in the customer relationship management server is not associated with the folder in the document storage server;
an associating unit configured to associate the sales opportunity with the new folder by transmitting the folder identification information to the customer relationship management server;
a sub-folder creation unit configured to transmit a request to the document storage server requesting that a new sub-folder be created in the folder created by the folder creation unit, the sub-folder corresponding to a category associated with the opportunity in the customer relationship management server; and
an upload unit configured to upload a document to the document storage server to be stored in the sub-folder corresponding to the category associated with the opportunity in the customer relationship management server.

9. The data matching and synchronization client according to claim 8, wherein the data matching and synchronization client is connected to the customer relationship management server and the document storage server via an external network.

10. The data matching and synchronization client according to claim 8, wherein the data matching and synchronization client is first authenticated with the customer relationship management server and the document storage server.

11. The data matching and synchronization client according to claim 8, wherein the data matching and synchronization client further comprises a display interface configured to display content from the customer relationship management server and the document storage server.

12. A document storage server executing a document storage service, comprising:
a folder creation unit configured to receive a request to create a new folder, to create the new folder, to generate folder identification information and to send the folder identification information corresponding to the new folder in response to the request;
a sub-folder creation unit configured to receive a request to create a sub-folder in the new folder and to create the sub-folder in the new folder in response to the request; and
a file storage unit configured to receive a document to be stored in the sub-folder and to store the document in the sub-folder in response to the receipt of the document.

13. A customer relationship management server comprising:
an opportunity information unit configured to store a correspondence between a sales opportunity and folder identification information associated with a folder in a document management server and to provide information regarding existence of the folder identification information in response to a request; and
a category association unit configured to associate a document with a category corresponding to the sales opportunity.

14. A computer readable medium storing thereon a program that when executed on a computer causes the computer to perform a method of data matching and synchronization between two applications, the method comprising:
judging whether a sales opportunity in a customer relationship management service is associated with a folder in the document storage service by requesting folder identification information from the customer relationship management service;
creating a new folder in the document storage service, obtaining folder identification information of the new folder, and associating the sales opportunity with the new folder when the judging determines that the sales opportunity in the customer relationship management service is not associated with the folder in the document storage service;
creating a new sub-folder in the new folder in the document storage service, the new sub-folder corresponding to a category associated with the sales opportunity;
uploading a file associated with the category and the sales opportunity to the document storage service; and
storing the uploaded file in the new sub-folder.

15. The computer readable medium according to claim 14, wherein the requesting folder identification information further includes sending a request which includes information relating to the sales opportunity.

16. The computer readable medium according to claim 14, further comprising:
creating a second new sub-folder in the new folder in the document storage service, the second new sub-folder corresponding to a second category associated with the sales opportunity.

17. The computer readable medium according to claim 16, further comprising:
uploading a second file associated with the second category and the sales opportunity to the document storage service.

18. The computer readable medium according to claim 17, further comprising:
storing the uploaded second file in the second new sub-folder.

19. The computer readable medium according to claim 14, wherein the step of creating a new folder in the document storage service, obtaining folder identification information of the new folder, and associating the sales opportunity with the new folder is performed in response to receipt at the document storage service of a request to create a folder sent by the client.

20. The computer readable medium according to claim 19, wherein the client sends the request to create a folder to the document storage service in response to a message from the customer relationship management service indicating that the sales opportunity in the customer relationship management service is not associated with a folder in the document storage service.
